(19) United States
(12) Patent Application Publication
(10) Pub. No.: US 2003/0184782 A1
(43) Pub. Date: Oct. 2, 2003

(54) Printer driver configured to dynamically receive printer self-description

(76) Inventors: Gregory E. Perkins, Boise, ID (US); Patrick O. Sandfort, Meridian, ID (US); James A. Hewitt, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/108,404

(22) Filed: Mar. 27, 2002

(51) Int. Cl. G06F 15/00; B41B 1/00

(52) U.S. Cl. 358/1.13

(57) ABSTRACT

A generic printer driver is configured to receive a printer description upon selection of a printer. The printer description is incorporated into the generic printer driver, thereby creating a specialized printer driver. The specialized driver is then able to present printer-specific printing options to the user, and to format a print job using low-level printer-specific commands and information, thereby taking advantage of the entire functionality of the printer.

### TECHNICAL FIELD

This disclosure relates to the incorporation of a selected printer's description into a generic printer driver.

### BACKGROUND

A typical printer driver resident on a workstation is closely associated with the printer with which it was designed to operate. The printer driver is therefore able to understand the functionality and features available on the printer, to present options to the user of the workstation, to communicate with the printer using low-level device-specific commands, and to customize the print job sent to the printer to result in the proper execution of the available printer functionality.

For example, in a PostScript® system, PPD (PostScript® Printer Description) files contain information specific to a printer. These substantially text-based files are incorporated into the design of the printer driver software which operates on a workstation. As a result, the printer driver is able to communicate with a specific printer using printer-specific low-level commands, and to thereby format a print job in a manner that will result in the correct print output on the specific printer. Thus, because a particular printer's PPD is integrated into the printer driver operable on a workstation, the user of the workstation is able to use and fully benefit from the functionality available on the printer associated with the PPD.

Unfortunately, any change in the printer, such as a firmware upgrade or replacement of the printer with a new model, will result in an incompatibility with the printer driver. As a result, the printer driver will have to be replaced.

In an attempt to overcome these deficiencies, a bi-directional printer driver may use SNMP (Simple Network Management Protocol) to interrogate the MIB (Management Information Base) of a printer. Such interrogation will reveal the specific characteristics available on the printer, thereby allowing the user to select from among a variety of features.

However, SNMP interrogation of the printer's MIB requires an in-depth knowledge of the MIB. Additionally, such bi-directional printer drivers also contain specific information which allows them to utilize the information obtained from the MIB. Changes to the printer's MIB may result in errors by the printer driver when attempting to obtain information. Other changes in the printer may contradict assumptions made in the design of the printer driver, thereby resulting in a failure to properly execute a print job. Thus, bi-directional printer drivers have generally failed to provide a satisfactory solution to the requirement of compatibility between a printer and an associated printer driver.

### SUMMARY

A generic printer driver is configured to receive a printer description upon selection of a printer. The printer description is incorporated into the generic printer driver, thereby creating a specialized printer driver. The specialized driver is then able to present printer-specific printing options to the user, and to format a print job using printer-specific commands and information, thereby taking advantage of the entire functionality of the printer.

### BRIEF DESCRIPTION OF THE DRAWINGS

The same numbers are used throughout the drawings to reference like features and components.

FIG. 1 is a block diagram illustrating the components of a first exemplary system environment wherein a printer driver is configured to dynamically receive a printer self-description provided by the printer to a printer driver.

FIG. 2 is a block diagram illustrating the components of a second exemplary system environment wherein a printer driver is configured to dynamically receive a printer description from a website.

FIG. 3 is a block diagram illustrating the components of a third exemplary system environment.

FIG. 4 illustrates an exemplary user interface allowing the user to select from among two or more printers.

FIG. 5 illustrates an exemplary user interface to allow the user to select from among printer-specific options.

FIG. 6 is a flow diagram that describes a method, wherein a generic printer driver is configured to dynamically receive a printer description, enabling it to reconfigure into a specialized printer driver capable of including the printer-specific commands and information required to format print jobs for the described printer.

FIG. 7 is a flow diagram that describes a method, wherein a compound printer driver is configured to dynamically receive a printer description, enabling it to reconfigure into a specialized printer driver capable of including the printer-specific commands and information required to format print jobs for the described printer.

FIG. 8 is a flow diagram that describes a method to update a printer and a printer description file.

### DETAILED DESCRIPTION

A generic printer driver is configured to receive a printer description upon selection of a printer. The printer description is incorporated into the generic printer driver, thereby creating a specialized printer driver. The specialized driver is then able to present printer-specific printing options to the user, and to format a print job using printer-specific commands and information, thereby taking advantage of the entire functionality of the printer.

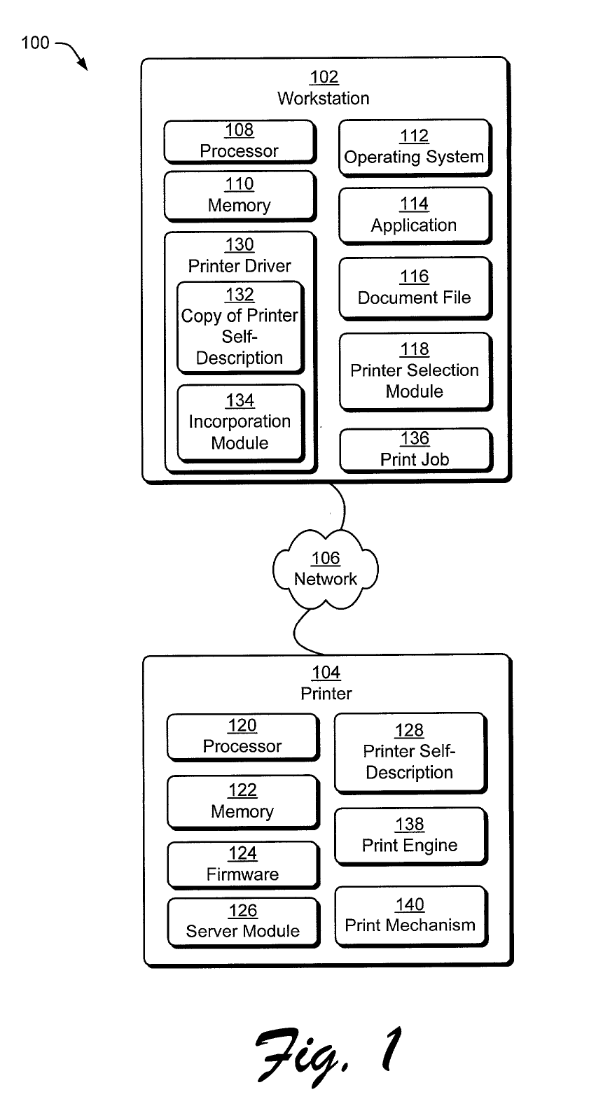

FIG. 1 shows a block diagram illustrating a system 100 for printing using a printer driver configured to dynamically receive and incorporate a self-description of a printer. A computer, such as workstation 102 communicates with a printer 104 over a network 106. The network may be a LAN (local area network), WAN (wide area network), a direct connection, the Internet or other means by which communication may be supported. The workstation 102 may include a processor 108 and memory 110. An operating system 112 supports the operation of an application 114, such as a word processor, which can be used to author a document file 116. The application and operating system are configured to allow the user to indicate the need to print the document by using a command available from within a user interface, such as a menu system, a keyboard equivalent command, or in some similar manner.

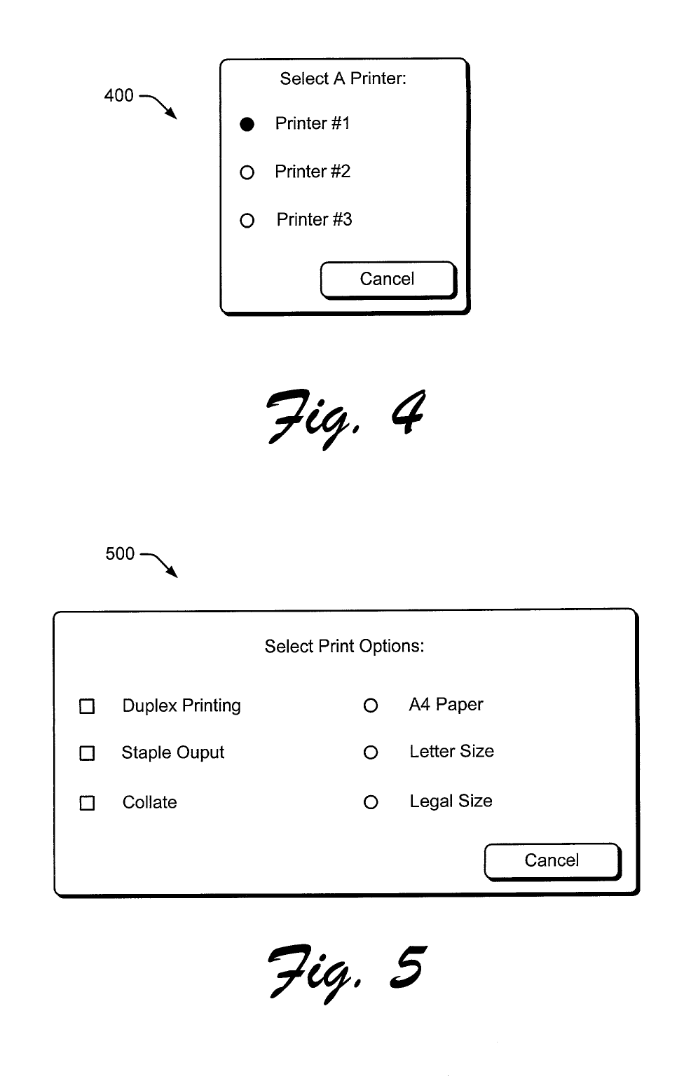

A printer selection module 118 is configured to receive indication that the user would like to print the document, and to allow the user to select a desired printer. In some applications, the user may select from among a number of printers on a local area network. The printer selection module provides a user interface, such as that seen in FIG. 4, to instruct the user to select a printer from among those available, or to cancel the print command. Alternatively, the user interface may present a field where the user can enter an arbitrary network address to select a printer. The printer selection module is configured to receive the user's input, and to request a printer description if one is needed.

The printer 104 includes a processor 120, memory 122 and firmware 124. A server module 126 is configured to receive a request for a printer self-description from the printer selection module 118, and to respond by providing the description 128. An exemplary printer self-description is configured in a structured data format, using alphanumeric characters to represent the data which describe the printer's structure and functionality. The printer self-description contains the information traditionally coded into a printer driver, which allows the printer driver to precisely control the operation of a specific printer. An example of the information contained within the printer description 128 is that information typically contained within a PPD (PostScript® Printer Description) file. Alternatively, the information contained within the printer description 128 could be a subset or a superset of a PPD. A variety of structured data formats could be used to contain the printer self-description, such as XML.

The printer driver 130 contained on the workstation is configured to receive a copy 132 of the printer self-description 128 provided by the server module 126 of the printer 104. An incorporation module 134 is configured to examine the printer self-description and to incorporate the data into the printer driver. Accordingly, the incorporation module is able to parse the XML format of the printer self-description, and to modify the printer driver behavior according to the information obtained. Incorporation of the data contained within the printer self-description enhances the ability of the printer driver to control the printer associated with the self-description. The enhancement allows the printer driver to translate generic commands into specialized commands, and to thereby control the printer. The generic commands received by the printer driver include those high-level commands an application and printing system will use in communicating with a printer driver. The commands may also include device-specific job options (e.g. stapling or even options not available at the time the printer was manufactured) which the self-description may propose and which the driver would otherwise not have been able to present and effect. Only generic commands are known to the application and printing system, since such an application does not know what specific printer is available. Specialized commands include low-level, device-specific commands particular to the printer, which are required to properly format a print job for a particular printer. The specialized commands will vary from printer to printer, because: available features and functionality differ from printer to printer; similar printers may have different firmware revision levels; and, printers manufactured by different companies and at different times tend to have different low-level and device-specific commands.

Incorporation of the printer self-description into the printer driver converts the printer driver from a generic state, able to process only commands common to most or all printers, into a specialized state, able to present printing options to users and able to process commands and information specific to the printer associated with the self-description.

The printer driver in the specialized state is configured to present a user interface, such as that seen in FIG. 5, to obtain the user's preferences for the appearance and nature of the output. For example, the user may select a desired paper size. The nature of the user interface is controlled by the operating system, the printer self-description, which controls the questions asked of the user, and the options presented to the user. The information obtained by the user interface will be reflected by the nature of the finished print job. The print job will also include the content of the document 116, as well as all of the printer-specific commands and information appropriate for transmission to the printer, as detailed by the printer self-description. The printer driver 130 is therefore able to create a printer-specific print job 136 from the document 116. The printer driver is additionally configured to send the completed print job to the printer for printing, and then to reconfigure to the generic state.

The printer 104 is configured to receive the print job 136, where a print engine 138 creates raster data, which is passed to a print mechanism 140 for application of an image to media.

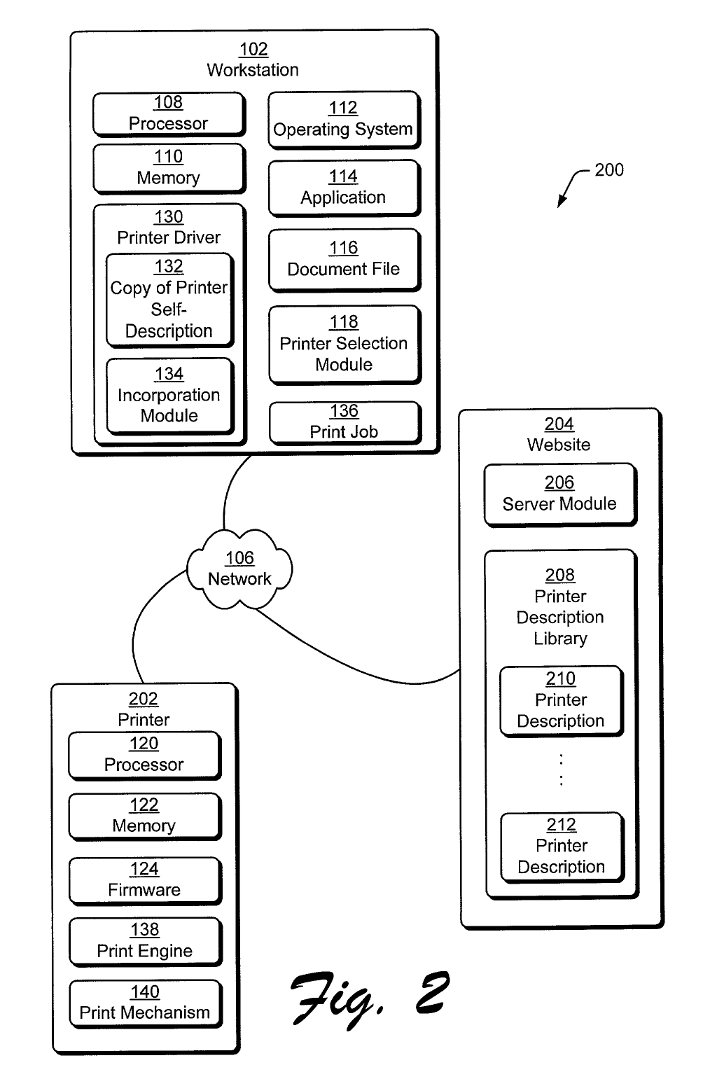

FIG. 2 shows a block diagram illustrating a system 200 for printing using a printer driver configured to dynamically receive and incorporate a description of a printer provided by an independent server. Where the workstation 102 is connected to a printer 202 by a network 106 such as the Internet, the printer description file may be provided to the workstation by a server 204. This may be advantageous where the printer 202 is not configured to provide a printer self-description file to the workstation.

The server, illustrated for purposes of example as website 204, includes a server module 206 which is configured to communicate with the printer selection module 118 of the workstation. The printer selection module indicates the printer selected, and the server module looks within a printer description library 208 to find the appropriate printer description 210 to 212. The printer description is formatted as seen above in an XML or similar structured data format, and is incorporated into the printer driver 130, thereby allowing generation of a print job, which is sent to the printer 202 for printing. The server 204 may interrogate the printer 202 via some mechanism such as SNMP, to fill in the dynamic parts of the printer description 210. The resulting information will be provided to the driver.

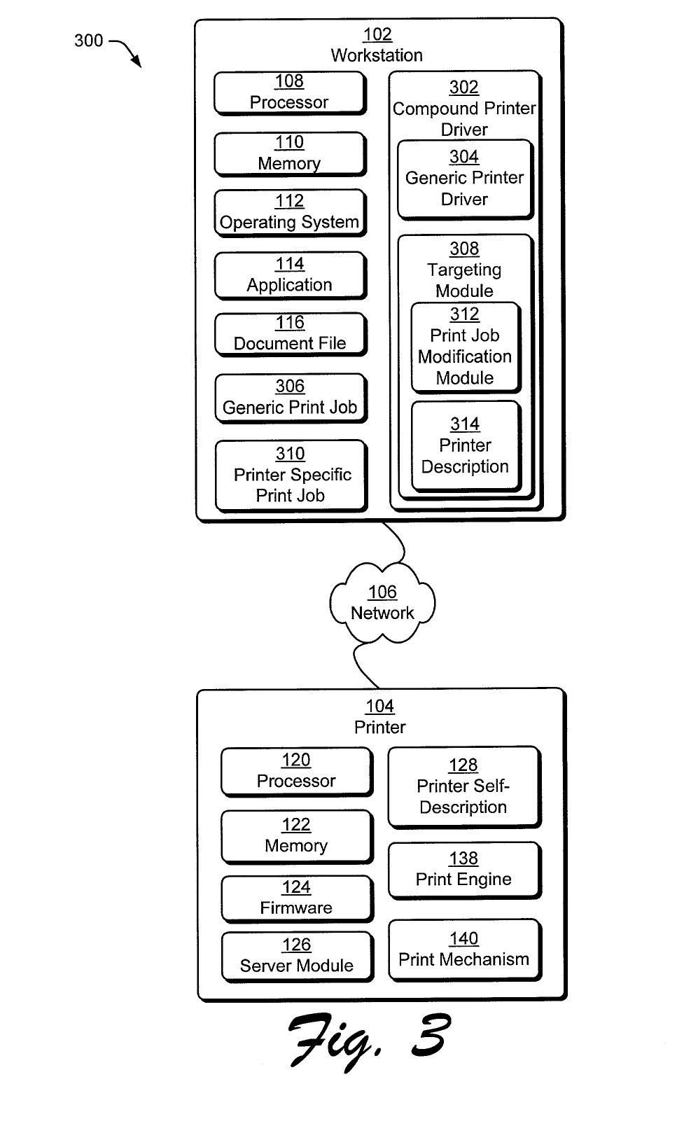

FIG. 3 shows a block diagram illustrating a system 300 for printing using a compound printer driver 302 configured to create a generic print job that can be interpreted by a significant group of printers. Additionally, the compound printer driver is configured to obtain specific information about the printer to which the print job is to be sent, and to modify the print job to include low-level, printer-specific commands and information which are able to exploit that printer's device-specific functionality.

The compound printer driver includes a generic printer driver portion 304, which is configured to generate a generic print job 306. The generic print job may include commands and information which allow the print job to be interpreted by any printer of a certain type of printers, such as PostScript® printers. Accordingly, the generic print job would not include commands or information that may vary between printers, such as instructions to collate or staple the output media.

The compound printer driver also includes a targeting module 308, which is configured to intercept and then to enhance the generic print job 306, by including printer-specific commands and information, thereby creating a printer specific print job 310 which is then sent to the printer. The targeting module targets the print job by providing an address of a printer to which the print job is to be sent. Additionally, by enhancing the print job to include printer-specific commands and information, the targeting module targets the print job for the specific printer to which the print job is being sent. In a Microsoft® Windows® environment, the targeting module could be configured as a port monitor having been modified to include means to enhance the generic print job to include printer-specific commands and information. In an alternative operating system and/or hardware environment, the targeting module would include a structure embodied in hardware, firmware and/or software, which is configured to enhance the generic print job to include printer-specific commands and information associated with the printer to which the print job is to be sent.

The targeting module includes a print job modification module 312, which is configured to allow a user to select, through a user interface, a desired printer to which to send the print job. The user interface may be of any desired style, and is typically suggested by the operating system used. The interface of FIG. 4 is a representative example.

The print job modification module 312 is also configured to request and receive printer-specific information 314 related to the selected printer. The printer-specific information may be a copy of the self-description 128, or may be a copy of the description 210, 212, provided by a third party, as seen in FIG. 2. The printer-specific information may be in XML or other structured data format. By incorporating the printer information, the targeting module portion of the compound printer driver obtains the functionality required to format a print job for a specific printer using printer-specific commands and information.

The print job modification module is also configured to present to the user an additional interface—or an extension of the interface which allowed printer selection—which invites selection of printer-specific options. Examples of printer—specific options—which may be presented to the user by an interface such as that seen in FIG. 5—include page collation, stapling and duplex printing.

The print job modification module is also configured to change the generic print job to reflect functionality available within a specific printer. The changes may be made directly to the generic print job, such as by direct modification of PostScript® commands. Alternatively, the modification may be made using PJL (Printer Job Language) commands which wrap the print job. The modifications made to the generic print job 306, which result in the specific print job 310, instruct the specific printer to which the job is sent to perform the indicated tasks. Because the indicated tasks are not available on all printers, the tasks could not have been included in the generic print job.

FIG. 4 illustrates an exemplary user interface 400 in the form of a dialog box, allowing the user to select from among two or more printers. The dialog box is presented to the user by the printer selection module, which processes the choice made by the user. Alternatively, the user may be invited to enter the network address of a printer not explicitly listed.

FIG. 5 illustrates an exemplary user interface 500 in the form of a dialog box that allows the user to select options which direct the manner in which the print job is formatted. In the example interface, the user is allowed to select options which will collate, print one or both sides, or staple the media. The user interface is not the same for all printers, since different printers have different functionality. Accordingly, the printer description includes information about possible printer-dependent options, how they may be presented in a user interface, and how they may be supported in the print job if selected.

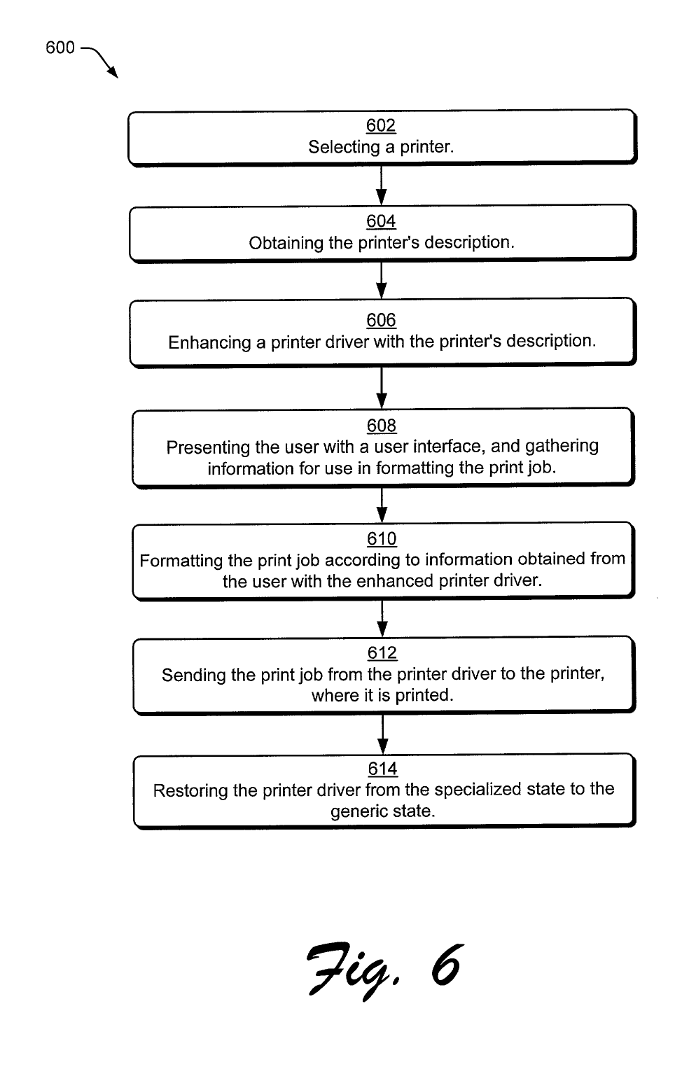

The flow chart of FIG. 6 illustrates a method 600 for incorporating a description of a printer into a generic printer driver or a printer driver in a generic state, thereby creating a specialized printer driver or a printer driver in a specialized state. The specialized printer driver is able to translate generic commands known by an application used to author a print job into low level, device- or printer-specific commands required to format the print job with complete control over the functionality of a particular printer. The elements of the method may be performed by any desired means, such as by the execution of processor-readable instructions defined on a processor-readable media, such as a disk, a ROM or other memory device. Also, actions may happen in parallel or in a different order, or even be distributed over many steps. For example, generic print job formatting and production could be performed before or in parallel with printer selection. Similarly, device-specific job features can be handled after the printer is selected.

At block 602, the user operating a workstation or other computer indicates a desire to print a document. Typically, this is done from within an application with which the user is authoring the document, by executing menu commands or the equivalent keyboard commands. Such a print command will trigger the printer selection module to display a user interface, such as a dialog box, which allows the user to select a desired printer. Alternatively, systems may also be configured to have a default printer, where selection is pre-determined, in a manner similar to the method by which static print-paths are currently implemented in Windows. In this implementation, further user input would not be needed.

At block 604, the workstation obtains the printer description file associated with the selected printer. In the print system 100 of FIG. 1, the printer description is provided by the printer; in the print system 200 of FIG. 2, the printer description is provided by the independent server. The printer description file may be sent in a structured data format, such as XML.

At block 606, the printer driver on the workstation receives the printer description file. An incorporation module enhances the printer driver from a generic state to a specialized state, or from a generic printer driver to a specialized printer driver. The change reflects the specific information contained within the printer description, and incorporated into the printer driver. Accordingly, the printer driver is able to communicate with the printer using low-level, device-specific commands that allow full control over the printer's characteristics.

At block 608, a user interface is presented to the user, allowing the user to select options to be applied to the user's print job. Such options include paper size, duplex printing, etc. The user interface may be in the form of a dialog box or similar structure.

At block 610, the printer driver formats the print job using specialized, low-level, and printer-specific commands resident within the enhanced printer driver. The print job formatting may be performed according to the information obtained from the user via the user interface, and typically contains content authored or obtained by the user using an application.

At block 612, the print job is sent to the printer by the printer driver, where it is printed. In many applications, the commands of the print job are embodied in a page description language, the interpretation of which results in raster data, thereby driving the print engine and print mechanism.

At block 614, the printer driver is restored from the specialized state associated with the selected printer to the generic state, ready to be enhanced into a specialized state associated with another printer.

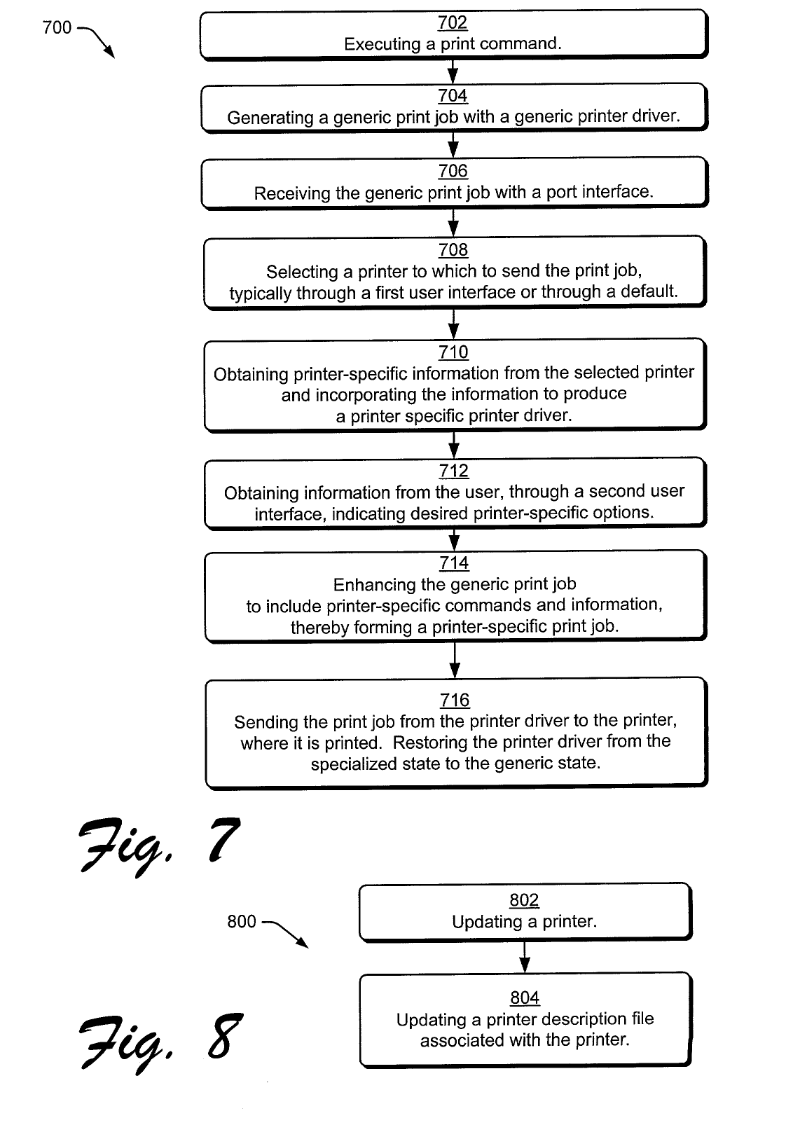

The flow chart of FIG. 7 illustrates a method 700 by which a compound printer driver, such as that seen in FIG. 3, creates a generic print job that is then enhanced to include printer-specific commands and information. A targeting module receives the generic print job and determines the printer to which the job should be directed. Where available, the targeting module obtains a printer description file and incorporates this file to form a device-specific printer driver. A user interface determines which printer-specific commands and data should be included with the generic print job, thereby directing the production of a printer specific print job. The targeting module then enhances the generic print job to include printer-specific commands and information, thereby further targeting the print job for processing by a specific printer. The elements of the method may be performed by any desired means, such as by the execution of processor-readable instructions defined on a processor-readable media, such as a disk, a ROM or other memory device. Also, actions may happen in parallel or in a different order, or even be distributed over many steps. For example, generic print job formatting and production could be performed before or in parallel with printer selection. Similarly, device-specific job features can be applied after the printer is selected.

At block 702, the user operating a workstation or other computer indicates a desire to print a document. Typically, this is done from within an application with which the user is authoring the document, by executing menu commands or the equivalent keyboard commands.

At block 704, a generic printer driver creates a generic print job, i.e. a print job having commands and information that can be interpreted by any appropriate printer, such as any PostScript® printer.

At block 706, the generic print job is received by, or intercepted by, a targeting module. The targeting module recognizes the generic print job and retains it for further processing.

At block 708, the targeting module presents the user with a first user interface, asking for the user to select a printer to which to send the generic print job. Alternatively, the printer selection may be made by first consulting a default, such as where only one printer is available.

At block 710, where possible, the targeting module obtains printer-specific information from the selected printer or other source. The printer-specific information may be formatted in XML or other means for transmission of structured data. The printer-specific information is incorporated into the targeting module, thereby enabling it to upgrade the print job to include printer-specific commands and information.

At block 712, the targeting module asks the user to select any desired printer-specific options through a continuation of the first user interface or a second user interface. Such options may include collating and/or stapling the printed media, duplex (two-sided) printing and other features.

At block 714, the generic print job is enhanced to include printer-specific commands and information, thereby forming a printer-specific print job. The printer specific commands and information may be in the form of modifications to a generic PostScript® file or include a PJL (Printer Job Language) wrapper surrounding the PostScript® print job which controls printer-specific commands and information.

At block 716, the print job is sent from the printer driver to the printer, where it is printed. The targeting module of the printer driver is then restored to the generic state from the specialized state.

The flow chart of FIG. 8 illustrates a method 800 for updating a printer and for updating a printer description file associated with the printer. The elements of the method may be performed by any desired means, such as by the execution of processor-readable instructions defined on a processor-readable media, such as a disk, a ROM or other memory device.

At block 802, under some circumstances, the printer is updated. The updating may include default settings or other internal state changing, or installation of new hardware such as a paper tray that will collate or staple media.

At block 804, the printer description or self-description file is replaced or altered, to reflect the changes in the printer. The printer description file may be located on the printer, as is the printer self-description file 128 in FIG. 1, or in an alternate location, such as the server 204 of FIG. 2.

In conclusion, a generic printer driver is configured to receive a printer description provided to the printer driver, upon selection of a printer and prior to formatting a print job. The printer description is incorporated into the generic printer driver, thereby creating a specialized printer driver. The specialized driver is able to present the user with device-specific printing options and to translate generic commands known by an application used to author the print job into low-level device-specific commands and information required for complete control over the functionality of the printer. The specialized printer driver is therefore able to fully control the printer associated with the printer description, and to format a print job for printing on the printer.

Although the disclosure has been described in language specific to structural features and/or methodological steps, it is to be understood that the appended claims are not limited to the specific features or steps described. Rather, the specific features and steps are exemplary forms of implementing this disclosure. For example, while an example of a user interface sent by a printer to a printer driver has been given, it is clear that variations on the user interface could be made, while still in keeping within the scope of the invention.

Additionally, while one or more methods have been disclosed by means of flow charts and text associated with the blocks, it is to be understood that the blocks do not necessarily have to be performed in the order in which they were presented, and that an alternative order, parallelizing, or distributing steps may result in similar advantages.

1. A processor-readable medium comprising processor-executable instructions for:
providing a description of a printer to a generic printer driver;
incorporating the description into the generic printer driver, thereby creating a specialized printer driver; and
formatting a print job using the specialized printer driver.

2. A processor-readable medium as recited in claim 1, comprising further instructions for:
formatting the description in XML.

3. A processor-readable medium as recited in claim 1, comprising further instructions for:
presenting a user with a user interface reflecting characteristics of the printer.

4. A processor-readable medium as recited in claim 3, comprising further instructions for:
including information obtained from the user through the user interface formatting the print job.

5. A processor-readable medium as recited in claim 1, comprising further instructions for:
printing the print job; and
restoring the specialized printer driver to the generic printer driver.

6. A processor-readable medium comprising processor-executable instructions for:
selecting a printer to which to send a print job;
obtaining a description of the printer;
enhancing a printer driver from a generic to a specialized state with the description;
obtaining a user interface associated with the printer;
formatting the print job with the print driver according to information received from the user interface; and
sending the print job to the printer.

7. A processor-readable medium as recited in claim 6, comprising further instructions for:
presenting a user with a printer selection interface to facilitate selecting the printer to which to send the print job.

8. A processor-readable medium as recited in claim 6, comprising further instructions for:
receiving the print job with the printer; and
printing the print job.

9. A processor-readable medium as recited in claim 6, comprising further instructions for:
updating the description of the printer in response to updating the printer.

10. A processor-readable medium comprising processor-executable instructions for configuring a printer driver to dynamically receive a printer description, the processor-executable instructions comprising instructions for:
receiving, by the printer driver in a generic state, the printer description in a structured data format;
incorporating the printer description into the printer driver, thereby upgrading the printer driver from a generic state to a specialized state capable of sending specialized commands to a printer;
presenting a user interface to a user, thereby obtaining information from the user to assist in formatting a print job using specialized commands;
formatting the print job using specialized commands;
sending the print job to the printer; and
restoring the printer driver from the specialized state to the generic state.

11. A system, comprising:
a printer, comprising:
a printer self-description;
a server module to provide the printer self-description; and
a user interface to allow selection of characteristics resident within the printer self-description; and
a workstation comprising:
a printer selection module to allow a user to select a printer;
a generic printer driver to receive and incorporate the printer self-description, and to thereby form a specialized printer driver.

12. The system of claim 11, wherein the server module is configured to provide the printer self-description in XML.

13. The system of claim 11, wherein the specialized printer driver is configured to revert to the generic printer driver after formatting a print job.

14. A printer driver, comprising:
means for obtaining a description of a printer;
means for incorporating the description into a printer driver while in a generic state, thereby transforming the printer driver into a specialized state;
means for formatting a print job using specialized commands recognized by the printer driver while in the specialized state; and
means for returning the printer driver to the generic state.

15. The printer driver as recited in claim 14, additionally comprising:
means for contacting a server to obtain the description of the printer.

16. The printer driver as recited in claim 14, additionally comprising:
means for presenting a user with a user interface reflecting functionality supported by a printer; and
means for utilizing information obtained by the user interface in generating specialized commands when formatting the print job.

17. A method for printing, comprising:
requesting a printer description from a selected printer;
transferring the printer description from the selected printer to a printer driver;
transferring a user interface from the selected printer to the printer driver for display to a user;
using the printer description and selected items from the user interface to format a print job; and
sending the print job to the selected printer.

18. A method as recited in claim 17, further comprising:
presenting the user with a printer selection dialog box to allow the user to select a desired printer.

19. A method as recited in claim 18, further comprising:
receiving the print job with the selected printer; and
printing the print job.

20. A method as recited in claim 19, further comprising:
updating the selected printer; and
updating the printer description contained within the selected printer.

21. A processor-readable medium comprising processor-executable instructions for:
providing a printer self-description from a printer to a generic printer driver;
incorporating the printer self-description into the generic printer driver, thereby creating a specialized printer driver; and
formatting a print job using the specialized printer driver.

22. A processor-readable medium as recited in claim 21, comprising further instructions for:
formatting the printer self-description in XML.

23. A processor-readable medium as recited in claim 21, comprising further instructions for:
presenting a user with a user interface reflecting characteristics of the printer.

24. A processor-readable medium as recited in claim 23, comprising further instructions for:
including information obtained from the user through the user interface formatting the print job.

25. A processor-readable medium as recited in claim 21, comprising further instructions for:
printing the print job; and
restoring the specialized printer driver to the generic printer driver.

26. A processor-readable medium as recited in claim 21, comprising further instructions for:
updating the printer; and
updating the printer self-description contained within the printer.

27. A method for printing, comprising:
providing a self-description of a printer from the printer to a generic printer driver;
incorporating the self-description into the generic printer driver, thereby creating a specialized printer driver; and
formatting a print job using the specialized printer driver.

28. A method as recited in claim 27, further comprising:
formatting the self-description in XML.

29. A method as recited in claim 27, further comprising:
presenting a user with a user interface reflecting characteristics of the printer.

30. A method as recited in claim 29, further comprising:
including information obtained from the user through the user interface formatting the print job.

31. A method as recited in claim 27, further comprising:
printing the print job; and
restoring the specialized printer driver to a generic printer driver.

32. A method as recited in claim 27, further comprising:
updating the printer; and
updating the self-description.

33. A processor-readable medium comprising processor-executable instructions for:
generating a generic print job with a generic printer driver;
selecting a printer with which the generic print job will be printed;
obtaining printer-specific information about the printer;
selecting desired printer-specific options; and
enhancing the generic print job to form a printer-specific print job including the desired printer-specific options.

34. A processor-readable medium as recited in claim 33, comprising further instructions for:
presenting a user interface to facilitate selecting the printer.

35. A processor-readable medium as recited in claim 33, comprising further instructions for:
presenting a user interface to facilitate selecting desired printer-specific options.

36. A processor-readable medium as recited in claim 33, comprising further instructions for:
intercepting the generic print job with a targeting module.

37. A processor-readable medium as recited in claim 33, comprising further instructions for:
incorporating the printer-specific information into a print job modification module within a targeting module.

38. A method for printing, comprising:
generating a generic print job with a generic printer driver;
selecting a printer with which the generic print job will be printed;
obtaining printer-specific information about the printer;
selecting desired printer-specific options; and
enhancing the generic print job to form a printer-specific print job including the desired printer-specific options.

39. A method as recited in claim 38 further comprising:
intercepting the generic print job with a targeting module.

40. A method as recited in claim 38 further comprising:
incorporating the printer-specific information into a print job modification module within a targeting module.

41. A compound printer driver, comprising:
a generic printer driver to produce a generic print job;
a targeting module to intercept the generic print job; and
a print job modification module, contained within the targeting module, to obtain printer-specific information and to use the printer-specific information to enhance the generic print job into a printer-specific print job.

42. The compound printer driver of claim 41, additionally comprising:
a user interface to allow selection of a desired printer and to allow selection of desired printer specific options associated with the desired printer.

43. The compound printer driver of claim 41, wherein the printer job modification module is configured to obtain printer-specific information in XML.

44. The compound printer driver of claim 41, wherein the printer job modification module is configured to wrap the generic print job with PJL commands and information.

45. The compound printer driver of claim 41, wherein the printer job modification module is configured to modify PostScript® commands within the generic print job.
